(19) United States
(12) Patent Application Publication
(10) Pub. No.: US 2025/0225461 A1
(43) Pub. Date: Jul. 10, 2025

(54) OPERATIONAL CYBERSECURITY RISK ASSESSMENT

(71) Applicant: Saudi Arabian Oil Company, Dhahran (SA)

(72) Inventor: Roshdi Ahmed Osman, Dekalb, IL (US)

(21) Appl. No.: 18/403,987

(22) Filed: Jan. 4, 2024

(51) Int. Cl. G06Q 10/0635; G06F 8/65; G06F 21/57; G06Q 10/0637

(52) U.S. Cl. CPC G06Q 10/0635; G06F 8/65; G06F 21/577; G06Q 10/06375

(57) ABSTRACT

Disclosed are methods, systems, and computer-readable media to perform operations including: A method for a cybersecurity risk assessment, including: acquiring information about business environment and business operations of a business entity; determining an engagement scope through facilitated sessions; performing cybersecurity control review and gap assessment to generate a control gap report and a control effectiveness report; performing cybersecurity threat analysis to generate an operational threat profile; performing a cybersecurity risk assessment to generate an operational risk profile; performing a business impact assessment to generate an operational impact profile; and providing the cybersecurity risk assessment to business sectors of the business entity.

### TECHNICAL FIELD

This disclosure relates generally to operational cybersecurity risk assessment.

### BACKGROUND

Cybersecurity risk assessment is a systematic process used to identify, evaluate, and prioritize potential risks and vulnerabilities within a business entity's information technology (IT) systems, networks, and data. The goal of a cybersecurity risk assessment is to understand the potential threats and their potential impact on a business entity's assets and operations, and to develop strategies to mitigate or manage these risks effectively.

Cybersecurity risk assessment is an ongoing process that requires regular updates and adjustments as the threat landscape evolves and the business entity's IT environment changes. It helps business entities proactively manage and mitigate risks to their sensitive data and operations.

### BRIEF DESCRIPTION OF THE FIGURES

FIG. 1 illustrates a flow chart of cybersecurity risk assessment, according to some implementations.

FIG. 2 illustrates a block diagram of an example cybersecurity risk assessment system, according to some implementations.

FIG. 3 is a schematic illustration of an example controller (or control system) that enables cybersecurity risk assessment.

### DETAILED DESCRIPTION

This disclosure describes methods and systems to identify, evaluate, and assess cybersecurity risks related to a business entity and its operations within the business entity. This disclosure describes comprehensive business-driven assessment techniques that understand the business environment and operations prior to evaluating threats and risks associated with the business operations. The techniques of this disclosure can identify and assess risks related to the business entity's contributions to the achievement of the overall operational objective of the business entity. The techniques of this disclosure enable cybersecurity professionals to better contextualize cybersecurity in business operational terms, taking into consideration the impact on business due to cybersecurity risk.

Existing cybersecurity risk assessment methodologies fall short when it comes to assessing operational risk due to people's behaviors and a business entity's cybersecurity culture. The techniques of this disclosure provide a mechanism to equally focus on people, processes, and technology when identifying and assessing cybersecurity risk within the business entity. The techniques of this disclosure further provide a mechanism to measure the potential impact of cybersecurity in business operations and articulate cybersecurity risks in operational terms.

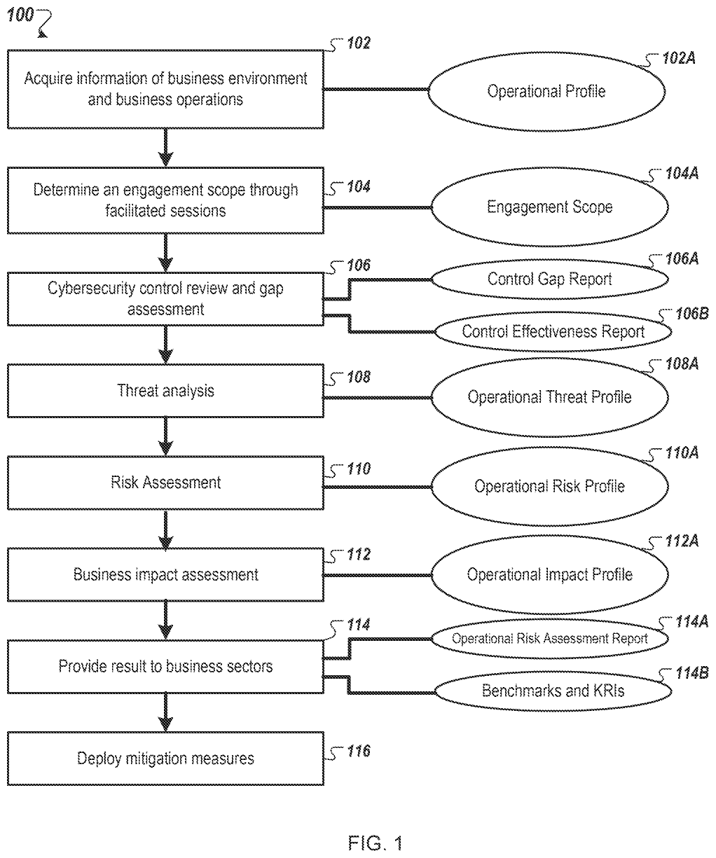

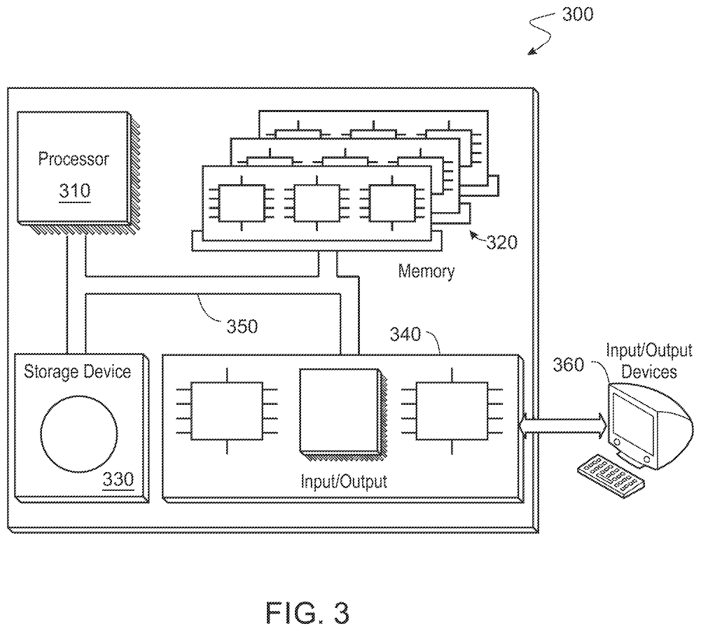

FIG. 1 illustrates a flow chart of cybersecurity risk assessment, according to some implementations. The process 100 is described as being performed by a risk assessor, a robot, or one or more computing devices including one or more processors or a controller, such as controller 300 of FIG. 3. The example process 100 shown in FIG. 1 can be modified or reconfigured to include additional, fewer, or different steps (not shown in FIG. 1), which can be performed in the order shown or in a different order.

At 102, a risk assessor acquires information of business environment and business operations. The risk assessor engages with a business analyst or a representative from a business entity who has a requisite knowledge of the business operations and an inclusive understanding of processes required to carry out the business operations of the business entity. For example, an operational profile 102A, which is a document that describes key operational aspects of a business entity, is provided to the risk assessor. The operational profile provides a detailed overview of how a business entity functions, including its core business processes, activities, and resources required to operate the business entity. The risk assessor can understand the fundamental business aspects of the business entity using the operational profile.

In some implementations, the business environment includes external factors, conditions, and forces that surround and affect a business entity's operations, performance, and decision-making processes. The business environment includes various elements that can have a significant impact on how a business entity operates in order to meet its objectives. Examples of the business environment include, but are not limited to, market conditions, regulatory and legal factors applicable to the business operations, supply chain related factors that may impact business operation, etc. Business operations refer to day-to-day activities and processes that a business entity engages in to produce, deliver, and manage its products or services.

At 104, the risk assessor determines an engagement scope through facilitated sessions. The risk assessor holds a plurality of facilitated sessions with subject matter experts (SMEs) of the business entity. The facilitated sessions are used to define the engagement scope 104A of the cybersecurity risk assessment with guidance from business SMEs, to ensure that the engagement scope 104A is directed to important activities for the business entity to carry out its operations. The facilitated sessions can build consensus between the risk assessor and the business SMEs on important activities included in the engagement scope 104A of the cybersecurity risk assessment.

A facilitated session is a structured meeting or workshop in which a trained risk assessor acts as a facilitator who guides and manages the discussions of participants (e.g., risk assessor, SMEs) in order to understand business operations, business environment, technology used, as well as potential cybersecurity risk and impact on business operations.

The engagement scope 104A refers to the defined boundaries and parameters that outline the specific goals, objectives, deliverables, and constraints of the risk assessment. The engagement scope 104A helps to establish clear expectations and boundaries for all parties involved in the cybersecurity risk assessment.

At 106, the risk assessor performs a cybersecurity control review and gap assessment to generate control gap report 106A and control effectiveness report 106B. The risk assessor can identify currently existing controls on each business process, as well as cybersecurity control gaps that needs to be addressed to enhance the protection of business operations. A cybersecurity control gap is a deficiency or shortfall in a business entity's processes, systems, or controls that can lead to a risk exposure.

The control gap report 106A is a document that identifies and highlights discrepancies or gaps between a business entity's existing internal controls and the desired control objectives or requirements. These gaps may arise due to various factors, such as changes in regulations, new business processes, technology upgrades, or evolving security threats. The purpose of a control gap report 106A is to assess where a business entity falls short in meeting its control objectives and to provide a roadmap for closing those gaps. The control effectiveness report 106B is a document or assessment that evaluates and communicates the effectiveness of internal controls within a business entity. Internal controls are processes, policies, and procedures put in place to safeguard assets, ensure accuracy in financial reporting, and maintain compliance with laws and regulations.

At 108, the risk assessor performs cybersecurity threat analysis to generate an operational threat profile 108A. The cybersecurity threat analysis determines the level of applicability and probability of evolving cybersecurity threats to one or more business processes. The cybersecurity threat analysis helps understand which component(s) of the business entity or its operational processes are exposed to an external or internal cybersecurity threats.

A component of a business entity refers to one of the parts or elements that make up the structure and functioning of a business or entity. These components are often distinct and serve different roles within the business entity. While components may vary depending on the business entity's type, size, and industry, some common components include business processes, infrastructure, policies and procedures, suppliers and partners, etc.

An operational threat profile 108A is a comprehensive documentation of cybersecurity threats that a business entity faces in its day-to-day operations. The operational threat profile 108A at least includes threat actors, threat vectors, vulnerabilities, and attack techniques. An operational threat profile 108A outlines various threats that a business entity's operational activities may face. The operational threat profile 108A can help a business entity to identify, analyze, and prepare for potential threats that can disrupt its normal business operation.

At 110, the risk assessor performs a cybersecurity risk assessment to generate an operational risk profile 110A. The cybersecurity risk assessment determines the level of risk associated with business operations. The cybersecurity risk assessment further determines the probability and the likelihood of a particular cybersecurity risk. An operational risk profile 110A is a comprehensive assessment and documentation of a business entity's exposure to operational risks. Operational risks are the risks associated with the day-to-day activities, processes, systems, and people within a business entity that can lead to financial losses, disruptions, or damage to its reputation.

At 112, the risk assessor performs a business impact assessment to generate an operational impact profile 112A. The risk assessor works with SMEs from various business sectors to determine a business impact if a cybersecurity risk materializes. Business impact refers to tangible effects or consequences resulting from the materialization of a risk. The impact of cybersecurity risks can include financial impact, reputation impact, legal impact, etc.

At 114, the risk assessor provides cybersecurity risk assessment to business sectors. The risk assessor reports and communicates the result of the business-driven risk assessment to various business sectors. The risk assessor can generate an operational risk assessment report 114A that articulates cybersecurity risk in business terms (e.g., operational profile, engagement scope, gap, operational threat profile, operational risk profile, operational impact profile, operational risk assessment report, benchmark, key risk indicator, etc.) in line with the business impact identified at 112. The risk assessor considers the overall cybersecurity posture of the business entity and other business entities within the same enterprise. The risk assessor further identifies and establishes benchmarks and cybersecurity key risk indicators (KRI) 114B applicable to operations of the assessed business entity.

Benchmarks are measurements used to assess, evaluate, and compare a business entity's risk and threat exposure to peers' business entities within the same enterprise or in the same business line. KRIs are metrics or data points used to monitor and measure the potential risks and early warning signs of emerging risks within a business entity. KRIs provide valuable information that helps a business entity to proactively identify, assess, and respond to risks before they escalate into significant issues.

At 116, the risk assessor deploys mitigation measures to address cybersecurity risks identified in the risk assessment. Mitigation measures are strategies and actions that a business entity can take to reduce or manage cybersecurity risks effectively. The mitigation measures include, e.g., patching, upgrading systems or isolating networks, etc. Patching is the process of applying updates and security patches to software, operating systems, and applications. It is typically done to fix known vulnerabilities and security issues. Upgrading involves replacing or updating entire systems or components, including hardware, software, or infrastructure. Upgrading is performed when existing systems are outdated and cannot be patched effectively. Network isolation, also known as network segmentation, involves physically or logically separating certain parts of a network to limit the potential impact of a security breach.

The techniques of this disclosure can solve the problem of misalignment of cybersecurity risk with business needs. The risk assessor can understand the nature of operations and priorities through facilitated sessions, and thus align cybersecurity risk with business objectives and operations.

The techniques of this disclosure can further solve the problem of inadequate scalability and coverage of cybersecurity risk in a large and complex IT and business environment. The risk assessor can prioritize cybersecurity risks in accordance with business priority. The techniques of this disclosure can provide a scalable mechanism to expand coverage across various business sectors within a large business entity.

The techniques of this disclosure integrate business processes and business operations into a cybersecurity risk assessment. The techniques of this disclosure assist in prioritizing risk mitigation measures based on requirements, nature, and characteristics of a business.

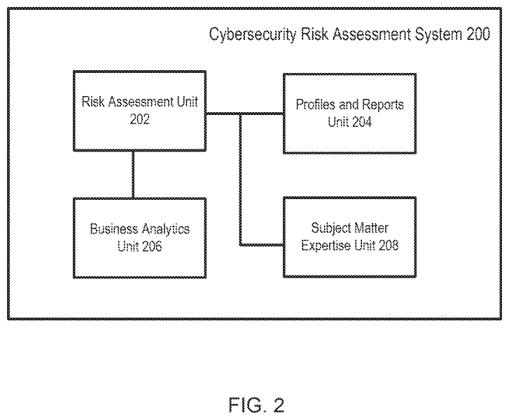

FIG. 2 illustrates a block diagram of an example cybersecurity risk assessment system 200, according to some implementations. The cybersecurity risk assessment system 200 can be used to perform the process 100 as illustrated in FIG. 1. The cybersecurity risk assessment system 200 can be implemented on a robot or one or more computing devices including one or more processors or a controller, such as controller 300 of FIG. 3.

The cybersecurity risk assessment system 200 includes risk assessment unit 202, profiles and reports unit 204, business analytics unit 206, and subject matter expertise unit 208. The business analytics unit 206 is configured to provide a requisite knowledge of the business operations and an inclusive understanding of processes required to carry out the business operations of a business entity. The subject matter expertise unit 208 is configured to work with risk assessment unit 202 to determine engagement scope 104A. The profiles and reports unit 204 is configured to work with risk assessment unit 202 to generate a plurality of profiles/reports, such as control gap report 106A, control effectiveness report 106B, operational threat profile 108A, operational risk profile 110A, operational impact profile 112A, operational risk assessment report 114A, benchmarks and KRIs 114B.

The risk assessment unit 202 is configured to acquire information of business environment and business operations from the business analytics unit 206, determine an engagement scope based on the expertise of the subject matter expertise unit 208, perform a cybersecurity control review and gap assessment to generate control gap report 106A and control effectiveness report 106B, perform cybersecurity threat analysis to generate an operational threat profile 108A, perform a cybersecurity risk assessment to generate an operational risk profile 110A, perform a business impact assessment to generate an operational impact profile 112A, provide cybersecurity risk assessment to business sectors, and deploy mitigation measures to address cybersecurity risks identified in the risk assessment.

FIG. 3 is a schematic illustration of an example controller 300 (or control system) that enables cybersecurity risk assessment. For example, the controller 300 may be operable according to the process 100 of FIG. 1. The controller 300 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 300 includes a processor 310, a memory 320, a storage device 330, and an input/output interface 340 communicatively coupled with input/output devices 360 (for example, displays, keyboards, measurement devices, sensors, valves, pumps). Each of the components 310, 320, 330, and 340 are interconnected using a system bus 350. The processor 310 is capable of processing instructions for execution within the controller 300. The processor may be designed using any of a number of architectures. For example, the processor 310 may be a CISC (Complex Instruction Set Computers) processor, a RISC (Reduced Instruction Set Computer) processor, or a MISC (Minimal Instruction Set Computer) processor.

In one implementation, the processor 310 is a single-threaded processor. In another implementation, the processor 310 is a multi-threaded processor. The processor 310 is capable of processing instructions stored in the memory 320 or on the storage device 330 to display graphical information for a user interface on the input/output interface 340.

The memory 320 stores information within the controller 300. In one implementation, the memory 320 is a computer-readable medium. In one implementation, the memory 320 is a volatile memory unit. In another implementation, the memory 320 is a nonvolatile memory unit.

The storage device 330 is capable of providing mass storage for the controller 300. In one implementation, the storage device 330 is a computer-readable medium. In various different implementations, the storage device 330 may be a floppy disk device, a hard disk device, an optical disk device, or a tape device.

The input/output interface 340 provides input/output operations for the controller 300. In one implementation, the input/output devices 360 includes a keyboard and/or pointing device. In another implementation, the input/output devices 360 includes a display unit for displaying graphical user interfaces.

There can be any number of controllers 300 associated with, or external to, a computer system containing controller 300, with each controller 300 communicating over a network. Further, the terms “client,” “user,” and other appropriate terminology can be used interchangeably, as appropriate, without departing from the scope of the present disclosure. Moreover, the present disclosure contemplates that many users can use one controller 300 and one user can use multiple controllers 300.

### Embodiments/Examples

According to some non-limiting embodiments or examples, provided is a computer-implemented method, for a cybersecurity risk assessment, comprising: acquiring information of business environment and business operations of a business entity; determining an engagement scope through facilitated sessions; performing cybersecurity control review and gap assessment to generate a control gap report and a control effectiveness report; performing cybersecurity threat analysis to generate an operational threat profile; performing the cybersecurity risk assessment to generate an operational risk profile; performing a business impact assessment to generate an operational impact profile; and providing the cybersecurity risk assessment to business sectors of the business entity.

According to some non-limiting embodiments or examples, provided is an apparatus comprising a non-transitory, computer readable, storage medium that stores instructions that, when executed by at least one processor, cause the at least one processor to perform operations comprising: acquiring information of business environment and business operations of a business entity; determining an engagement scope through facilitated sessions; performing cybersecurity control review and gap assessment to generate a control gap report and a control effectiveness report; performing cybersecurity threat analysis to generate an operational threat profile; performing a cybersecurity risk assessment to generate an operational risk profile; performing a business impact assessment to generate an operational impact profile; and providing the cybersecurity risk assessment to business sectors of the business entity.

According to some non-limiting embodiments or examples, provided is a system, comprising: one or more memory modules; one or more hardware processors communicably coupled to the one or more memory modules, the one or more hardware processors configured to execute instructions stored on the one or more memory models to perform operations comprising: acquiring information of business environment and business operations of a business entity; determining an engagement scope through facilitated sessions; performing cybersecurity control review and gap assessment to generate a control gap report and a control effectiveness report; performing cybersecurity threat analysis to generate an operational threat profile; performing a cybersecurity risk assessment to generate an operational risk profile; performing a business impact assessment to generate an operational impact profile; and providing the cybersecurity risk assessment to business sectors of the business entity.

Further non-limiting aspects or embodiments are set forth in the following numbered embodiments:

Embodiment 1: A method for a cybersecurity risk assessment, comprising: acquiring information of business environment and business operations of a business entity; determining an engagement scope through facilitated sessions; performing cybersecurity control review and gap assessment to generate a control gap report and a control effectiveness report; performing cybersecurity threat analysis to generate an operational threat profile; performing the cybersecurity risk assessment to generate an operational risk profile; performing a business impact assessment to generate an operational impact profile; and providing the cybersecurity risk assessment to business sectors of the business entity.

Embodiment 2: The method of Embodiment 1, further comprising deploying one or more mitigation measures to address cybersecurity risks included in the cybersecurity risk assessment.

Embodiment 3: The method of any one of previous Embodiments, wherein the information of the business environment and the business operations includes an operational profile.

Embodiment 4: The method of any one of previous Embodiments, wherein the operational threat profile includes threat actors, threat vectors, vulnerabilities, and attack techniques.

Embodiment 5: The method of Embodiment 2, wherein the one or more mitigation measures include patching, upgrading or network isolation.

Embodiment 6: An apparatus comprising a non-transitory, computer readable, storage medium that stores instructions that, when executed by at least one processor, cause the at least one processor to perform operations comprising: acquiring information of business environment and business operations of a business entity; determining an engagement scope through facilitated sessions; performing cybersecurity control review and gap assessment to generate a control gap report and a control effectiveness report; performing cybersecurity threat analysis to generate an operational threat profile; performing a cybersecurity risk assessment to generate an operational risk profile; performing a business impact assessment to generate an operational impact profile; and providing the cybersecurity risk assessment to business sectors of the business entity.

Embodiment 7: The apparatus of Embodiment 6, the operations further comprising deploying one or more mitigation measures to address cybersecurity risks included in the cybersecurity risk assessment.

Embodiment 8: The apparatus of Embodiments 6 or 7, wherein the information of the business environment and the business operations includes an operational profile.

Embodiment 9: The apparatus of any one of Embodiments 6-8, wherein the operational threat profile includes threat actors, threat vectors, vulnerabilities, and attack techniques.

Embodiment 10: The apparatus of Embodiment 7, wherein the one or more mitigation measures include patching, upgrading or network isolation.

Embodiment 11: A system, comprising: one or more memory modules; one or more hardware processors communicably coupled to the one or more memory modules, the one or more hardware processors configured to execute instructions stored on the one or more memory models to perform operations comprising: acquiring information of business environment and business operations of a business entity; determining an engagement scope through facilitated sessions; performing cybersecurity control review and gap assessment to generate a control gap report and a control effectiveness report; performing cybersecurity threat analysis to generate an operational threat profile; performing a cybersecurity risk assessment to generate an operational risk profile; performing a business impact assessment to generate an operational impact profile; and providing the cybersecurity risk assessment to business sectors of the business entity.

Embodiment 12: The system of Embodiment 11, the operations further comprising deploying one or more mitigation measures to address cybersecurity risks included in the cybersecurity risk assessment.

Embodiment 13: The system of Embodiments 11 or 12, wherein the information of the business environment and the business operations includes an operational profile.

Embodiment 14: The system of any one of Embodiments 11-13, wherein the operational threat profile includes threat actors, threat vectors, vulnerabilities, and attack techniques.

Embodiment 15: The system of Embodiment 12, wherein the one or more mitigation measures include patching, upgrading or network isolation.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Various components may be described as performing a task or tasks, for convenience in the description. Such descriptions should be interpreted as including the phrase “configured to.” Reciting a component that is configured to perform one or more tasks is expressly intended not to invoke 35 USC § 112(f) interpretation for that component.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

We claim:

1. A method for a cybersecurity risk assessment, comprising:
acquiring information of business environment and business operations of a business entity;
determining an engagement scope through facilitated sessions;
performing cybersecurity control review and gap assessment to generate a control gap report and a control effectiveness report;
performing cybersecurity threat analysis to generate an operational threat profile;
performing the cybersecurity risk assessment to generate an operational risk profile;
performing a business impact assessment to generate an operational impact profile; and
providing the cybersecurity risk assessment to business sectors of the business entity.

2. The method of claim 1, further comprising deploying one or more mitigation measures to address cybersecurity risks included in the cybersecurity risk assessment.

3. The method of claim 1, wherein the information of the business environment and the business operations includes an operational profile.

4. The method of claim 1, wherein the operational threat profile includes threat actors, threat vectors, vulnerabilities, and attack techniques.

5. The method of claim 2, wherein the one or more mitigation measures include patching, upgrading or network isolation.

6. An apparatus comprising a non-transitory, computer readable, storage medium that stores instructions that, when executed by at least one processor, cause the at least one processor to perform operations comprising:
acquiring information of business environment and business operations of a business entity;
determining an engagement scope through facilitated sessions;
performing cybersecurity control review and gap assessment to generate a control gap report and a control effectiveness report;
performing cybersecurity threat analysis to generate an operational threat profile;
performing a cybersecurity risk assessment to generate an operational risk profile;
performing a business impact assessment to generate an operational impact profile; and
providing the cybersecurity risk assessment to business sectors of the business entity.

7. The apparatus of claim 6, the operations further comprising deploying one or more mitigation measures to address cybersecurity risks included in the cybersecurity risk assessment.

8. The apparatus of claim 6, wherein the information of the business environment and the business operations includes an operational profile.

9. The apparatus of claim 6, wherein the operational threat profile includes threat actors, threat vectors, vulnerabilities, and attack techniques.

10. The apparatus of claim 7, wherein the one or more mitigation measures include patching, upgrading or network isolation.

11. A system, comprising:
one or more memory modules;
one or more hardware processors communicably coupled to the one or more memory modules, the one or more hardware processors configured to execute instructions stored on the one or more memory modules to perform operations comprising:
acquiring information of business environment and business operations of a business entity;
determining an engagement scope through facilitated sessions;
performing cybersecurity control review and gap assessment to generate a control gap report and a control effectiveness report;
performing cybersecurity threat analysis to generate an operational threat profile;
performing a cybersecurity risk assessment to generate an operational risk profile;
performing a business impact assessment to generate an operational impact profile; and
providing the cybersecurity risk assessment to business sectors of the business entity.

12. The system of claim 11, the operations further comprising deploying one or more mitigation measures to address cybersecurity risks included in the cybersecurity risk assessment.

13. The system of claim 11, wherein the information of the business environment and the business operations includes an operational profile.

14. The system of claim 11, wherein the operational threat profile includes threat actors, threat vectors, vulnerabilities, and attack techniques.

15. The system of claim 12, wherein the one or more mitigation measures include patching, upgrading or network isolation.
